(19) United States
(12) Patent Application Publication
(10) Pub. No.: US 2010/0031668 A1
(43) Pub. Date: Feb. 11, 2010

(54) PROCESS AND INSTALLATION FOR GENERATING ELECTRICAL ENERGY IN A GAS AND STEAM TURBINE (COMBINED CYCLE) POWER GENERATING PLANT

(76) Inventor: Leopold Werner Kepplinger, Leonding (AT)

Correspondence Address: OSTROLENK FABER GERB & SOFFEN, 1180 AVENUE OF THE AMERICAS, NEW YORK, NY, 100368403, US

(21) Appl. No.: 12/522,078

(22) PCT Filed: Dec. 18, 2007
(86) PCT No.: PCT/EP07/11117

§ 371 Date: Jul. 2, 2009

(30) Foreign Application Priority Data
Jan. 15, 2007 (AT) A 73/2007

(51) Int. Cl. F01K 23/06; F02C 6/00

(52) U.S. Cl. 60/780; 60/39.12; 290/52

(57) ABSTRACT

A process for generating electrical energy in a gas and steam turbine (combined cycle) power generating plant with a gasification gas produced from carbon carriers and oxygen-containing gas. Carbon carriers are gasified in a gassing zone with oxygen or a gas containing a large amount of oxygen. Gasification gas produced is passed through a desulfurizing zone containing a desulfurizing agent. Used desulfurizing agent is fed into the gassing zone and drawn off after the formation of a liquid slag. Desulfurized gasification gas is burned in a combustion chamber. The resulting combustion gases H₂O and CO₂ are introduced into the gas turbine for energy generation. Downstream of the gas turbine, the combustion gases are separated in a steam boiler into water vapor and carbon dioxide. The water vapor is subsequently introduced into a steam turbine. The carbon dioxide is at least partially returned to the combustion chamber for setting the temperature.

The invention relates to a process for generating electrical energy in a gas and steam turbine (combined cycle) power generating plant with a gasification gas produced from carbon carriers and oxygen-containing gas and also to an installation for carrying out this process.

### BACKGROUND OF THE INVENTION

Around the middle of the 20th century, the first power generating plants with a gas turbine and downstream waste heat recovery for use in a steam turbine were constructed. They are referred to in the industry as gas and steam turbine power generating plants or as combined cycle power generating plants. All these plants are fuelled by natural gas, which can be converted into mechanical energy with satisfactory efficiency in gas turbines. The high purity of the natural gas also makes it possible for them to be operated without any major corrosion problems, even at the high blade temperatures of the turbine. The hot waste gas of the steam turbine is used in a downstream steam boiler for generating high-pressure steam for use in downstream steam turbines. This combination allows the highest electrical efficiencies currently attainable for thermal power generating plants to be achieved.

Other fuels, in particular solid fuels such as coal, could not be used for this technology. The IGCC (Integrated Gasification Combined Cycle) technology described below is intended to solve this problem. With this technology, a coal gasifier is used for producing the combustion gas required for the gas turbine. Gasifying coal produces a clean gas which satisfies the requirements of the gas turbines.

However, the treatment of the raw gas occurring during the gasification in the conventional gasifiers is a very demanding operation. Contaminants in dust form have to be washed out. Furthermore, depending on the gasifying process, all the condensable organic carbons have to be removed. Great attention also has to be paid to sulfur, which occurs during gasification as H₂S and COS. However, a purity that is acceptable for gas turbines can be achieved by gas cleaning stages.

As waste products, sulfur, coal ash and also organic and inorganic pollutants have to be discharged and sent for safe disposal in landfill sites or rendered harmless. This gives rise to high disposal costs. When carbon dioxide is separated for sequestering, complex, expensive and not very effective installations are necessary due to the relatively low carbon dioxide concentrations in the flue gas. Therefore, carbon monoxide is converted into carbon dioxide by what is known as the shift reaction, which requires the installation to have an additional part.

### PRIOR ART

Description of the IGCC Process of a Siemens Concept

Air separation: pure oxygen is necessary for the gasification. For this purpose, air is compressed to 10-20 bar by the compressor of the gas turbine or by a separate compressor and liquefied. The separation of the oxygen takes place by distillation at temperatures around −200° C.

Gasification: this produces a raw gas which mainly comprises carbon monoxide (CO) and hydrogen (H₂). With water vapor, CO is converted into CO₂ and further hydrogen. For the gasification of solid fuels, such as coal or petroleum coke, there are three basic processes, of which entrained-flow gasification dominates as far as IGCC is concerned: coal dust is fed under pressure by means of a carrier gas such as nitrogen to a burner and converted in the gasifier with oxygen and water vapor to form the synthesis gas.

Raw gas cooling: the synthesis gas must be cooled before further treatment. This produces steam, which contributes to the power generation in the steam turbine of the combined cycle installation.

Cleaning: after cooling the gas, filters initially hold back ash particles, while carbon dioxide can also be subsequently extracted if need be. Other pollutants, such as sulfur or heavy metals, are likewise bound by chemical and physical processes. This at the same time provides the necessary purity of the fuel for operating the gas turbines.

Combustion: the hydrogen-rich gas is mixed with nitrogen from the air separation or with water vapor upstream of the combustion chamber of the gas turbine. This lowers the combustion temperature and in this way largely suppresses the formation of nitrogen oxides. The flue gas produced by the combustion with air flows onto the blades of the gas turbine. It substantially comprises nitrogen, CO₂ and water vapor. The mixing with nitrogen or water causes the specific energy content of the gas to be reduced to around 5000 kJ/kg. Natural gas, on the other hand, has ten times the energy content. Therefore, for the same power output, the fuel mass flow through the gas turbine burner in the case of an IGCC power generating plant must be around ten times higher.

Waste gas cooling: after expansion of the flue gas in the gas turbine and subsequent utilization of the waste heat in a steam generator, the waste gas is discharged to the atmosphere. The steam flows from the cooling of the raw gas and the waste gas are combined and passed on together to the steam turbine. After expansion in the steam turbine, the steam passes by way of the condenser and the feed water tank back into the water or steam cycle. The gas or steam turbines are therefore coupled with a generator, in which the conversion into electrical energy takes place.

The high combustion temperatures in the combustion chamber of the gas turbine have the effect that the reaction with the nitrogen produces a high level of NOx in the waste gas, which has to be removed by secondary measures, such as SCR processes.

A further restriction for a combined cycle power generating plant operated with coal gas is also attributable to the currently restricted gasification performances of the gasification processes that are available on the market.

Three variants of the process have been put onto the market:
fixed bed process for lump coal
fluidized bed process for fine-grain coal and
entrained-flow process for coal dusts

Numerous variants of all these processes have been developed, operating for example under pressure or having a liquid slag discharge, etc. Some of these are described below.

Lump Coal Gasification: LURGI

This type of gasifier has a tradition dating back many decades and is used worldwide for coal gasification. Apart from hard coal, lignite may also be used under modified operating conditions. A disadvantage of this process is that it produces a series of byproducts, such as tars, slurries and inorganic compounds such as ammonia. This makes sophisticated gas cleaning and treatment necessary. It is also necessary to make use of or dispose of these byproducts. On the plus side there is the long experience with this plant, which has been built for over 70 years. However, because of the fixed bed type of operation, only lump coal can be used. A mixture of oxygen and/or air and water vapor is used as the gasification medium. The water vapor is necessary for moderating the gasification temperature, in order not to exceed the ash melting point, since this process operates with a solid ash discharge. As a result, the efficiency of the gasification is adversely influenced.

As a result of the counter-current type of operation, the temperature profile of the coal ranges from ambient temperature at the feed to the gasification temperature just above the ash grating. This means that pyrolysis gases and tars leave the gasifier with the raw gas and have to be removed in a downstream gas cleaning operation. Byproducts similar to those in a coking plant occur thereby.

The largest of these gasifiers have a throughput of approximately 24 tonnes of coal (daf=dry and ash free)/hour and generate about 2250 m³ₙ of raw gas/tonne of coal (daf). Produced as a byproduct are 40-60 kg of tar/tonne of coal (daf). The oxygen requirement is 0.14 m³ₙ/m³ₙ of gas. The operating pressure is 3 MPa. The residence time of the coal in the gasifier is 1-2 hours. The largest gasifiers have an internal diameter of 3.8 m. Over 160 units have so far been put into operation.

Gas composition when hard coal is used (South Africa)

CO₂ 32.0%

CO 15.8%

H₂ 39.8%

CH₄ 11.8%

CₙHₘ 0.8%

Fluidized Bed Gasifier for Fine Coal

Various types are currently available, the high-temperature Winkler gasifier being considered the most developed variant at present, since it delivers a pressure of approximately 1.0 MPa and operates at higher temperatures than other fluidized bed gasifiers. Based on brown coal, two units are currently in operation. The ash discharge is dry. However, at 1 tonne of coal/hour, the power output is too small to be able to cover the gas demand of an IGCC installation. The conventional Winkler gasifier delivers pressures that are too low, of approximately 0.1 MPa. The power output of these gasifiers is approximately 20 tonnes of coal/hour.

Gasifier with Liquid Slag Outlet for Coal and Natural Gas Residues

For the production of reducing gas, fine-grain carbon carriers may also be used. A common characteristic of these processes is a largely liquid slag. The following processes are used today:

Koppers-Totzek Process

Fine coal and oxygen are used as the feedstock. Water vapor is added to control the temperature. The slag is granulated in a water bath. The high gas temperature is used for obtaining the steam. The pressure is too low for IGCC power generating plants.

Prenflo Process

Fine coal and oxygen are used as the feedstock. This is a further development of the Koppers-Totzek process, which operates under a pressure of 2.5 MPa and would be suitable for IGCC power generating plants. However, there are so far no large-scale commercial plants.

Shell Process

Fine coal and oxygen are used as the feedstock. This process is also not yet commercially available in larger units. Its operating pressure of 2.5 MPa would make it suitable for IGCC power generating plants.

Texaco Process

This process has already been used for years in a number of operating units. However, at approximately 6-8 tonnes of coal (daf)/hour, the throughput is too small for IGCC power generating plants of a larger capacity. A number of plants have to be operated in parallel, which means that investment costs are high. This has an adverse influence on cost-effectiveness. The operating pressure is 8 MPa.

Oxyfuel Combustion

In the case of this process, the aim is not to achieve gasification but combustion. In the oxyfuel processes, the nitrogen is removed from the combustion air by air separation. Since combustion with pure oxygen would lead to combustion temperatures that are much too high, part of the waste gas is returned and consequently replaces the nitrogen from the air. The waste gas to be discharged substantially comprises only CO₂, since the water vapor has condensed out and contaminants such as SOx, NOx and dust have been eliminated.

Although air liquefaction has already been used on an industrial scale for providing oxygen at up to approximately 5000 tonnes of O₂/day, which is equivalent to the consumption of a 300 MW_{c} coal-fired power generating plant, the great problem of such plants is the high energy consumption of approximately 250-270 kWh/tonne of O₂, which increases still further with increasing purity requirements. There is also no safely established way of using the slag that is formed from the coal ashes.

Smelt Reduction Process

In the case of smelt reduction processes for producing pig iron from coal and ores, mainly iron ores, export gases of differing purity and calorific value are produced and their thermal contact put to use. In particular in the case of the COREX® and FINEX® processes, the export gas is of a quality that is ideal for combustion in gas turbines. Both the sulfur and the organic and inorganic pollutants have been removed from the gas within the metallurgical process. The export gas of these processes can be used without restriction for a combined cycle power generating plant.

A combined cycle installation with a Frame 9E gas turbine with a power output of 169 MW has been installed by General Electric in the new COREX® C-3000 plant for Baoshan Steel in China.

The idea of coupling a COREX® plant with an energy-efficient power generating plant based on the combined cycle system is not new. Back in 1986, an application for a patent (EP 0 269 609 B1) for this form of highly efficient energy conversion was filed and granted. A further patent (AT 392 079 B) describes a process of a similar type, the separation of the fine fraction and the coarse fraction making it possible to avoid the crushing of coal.

Since pure oxygen for the gasification of the carbon carriers is required for advantageous operation of an IGCC power generating plant, integrated generation of oxygen by means of the fuel gases produced in the gasification installation is possible. This is described in the German patent specification DE 39 08 505 C2.

The patent specification EP 90 890 037.6 describes a “process for generating combustible gases in a fusion gasifier”.

A disadvantage of all these cited processes is that air is used for the combustion of the combustion gas in the gas turbine. On the one hand, this has the result that there are disadvantageously large amounts of waste gas, which cause high enthalpic heat losses through the waste gas due to the limited end temperature in the chain of use up to the waste heat boiler, on the other hand the high efficiency of combined cycle power generating plants is reduced as a result. The waste gas has a high nitrogen content of up to over 70%, which makes sequestering of CO₂ much more difficult and therefore requires large, and consequently expensive, separating installations.

In the case of the oxyfuel process, although CO₂ is returned directly to the process, the gas must first be cleaned of pollutants, which is a very demanding process. The pollutants must be discharged, and consequently have an environmental impact. So far no operational installation exists. The problem of making use of the slag has not been solved either.

### OBJECT OF THE INVENTION

The present invention aims to avoid and overcome the aforementioned problems and disadvantages occurring in the prior art and has the object of providing a process for generating electrical energy in a gas and steam turbine (combined cycle) power generating plant which makes it possible to obtain energy with the smallest possible occurrence of pollutants and an increased carbon dioxide content in the waste gas for the purpose of more economic sequestering. In particular, it is intended that all the inorganic pollutants and organic compounds from the coal can be rendered harmless within the process and at the same time indestructible pollutants, such as sulfur, or harmful constituents of the ashes of fuels can be bound up in reusable products.

This object is achieved according to the invention in the case of a process of the type mentioned at the beginning in that
the carbon carriers are gasified in a gassing zone with oxygen or a gas containing a large amount of oxygen, with an oxygen content of at least 95% by volume, preferably at least 99% by volume,
the gasification gas produced in this way is passed through a desulfurizing zone containing a desulfurizing agent, used desulfurizing agent being fed into the gassing zone and drawn off after the formation of a liquid slag,
the desulfurized gasification gas, preferably following cleaning and cooling, is burned in a combustion chamber together with pure oxygen and the resulting combustion gases H₂O and CO₂ are introduced into the gas turbine for energy generation,
downstream of the gas turbine, the combustion gases are separated in a steam boiler into water vapor and carbon dioxide,
the water vapor is subsequently introduced into a steam turbine, and
* the carbon dioxide is at least partially returned to the combustion chamber for setting the temperature.

According to a preferred embodiment, iron and/or iron ore is/are additionally used as an auxiliary agent in the desulfurizing zone, fed together with the used desulfurizing agent into the gassing zone, melted there and drawn off.

The iron drawn off from the gassing zone is preferably returned to the desulfurizing zone.

A further preferred embodiment of the invention is characterized in that iron ore is additionally used in the desulfurizing zone, pre-heated and pre-reduced in the desulfurizing zone, fed together with the used desulfurizing agent into the gassing zone, completely reduced there, melted and drawn off as pig iron.

With particular preference, the desulfurizing of the gasifier gas and the pre-heating and pre-reduction of the iron ore are carried out in two or more fluidized bed zones arranged one behind the other, the iron ore being passed from fluidized bed zone to fluidized bed zone and the gasifier gas flowing through the fluidized bed zones in a direction counter to that of the iron ore.

A temperature >800° C., preferably >850° C., is preferably set in the gassing zone.

CO₂ or mixtures of CO, H₂, CO₂ and water vapor is/are advantageously used for all purging operations in the process.

The liquid slag formed in the gassing zone is preferably used in cement production.

The installation according to the invention for carrying out the above process, which comprises a gasifier for carbon carriers, which has a feed for carbon carriers, a feed line for an oxygen-containing gas, a discharge line for liquid slag and a discharge line for the gasifier gas produced, comprises a desulfurizing device, which has a feed for desulfurizing agent, a feed for the gasifier gas and a discharge line for the cleaned gasifier gas, and comprises a combined gas and steam turbine power generating plant with a combustion chamber of the gas turbine installation, into which there leads a line for the cleaned gasifier gas and a feed for oxygen-containing gas, and comprises a steam boiler of the steam turbine installation, into which there leads a line for the combustion gases extending from the gas turbine and which has a discharge line for flue gases, is characterized in that
the gasifier is formed as a fusion gasifier with a coal and/or char bed and is provided with a tap for liquid slag,
the feed line for the oxygen-containing gas is a feed line for oxygen or a gas containing a large amount of oxygen, which has an oxygen content of at least 95% by volume, preferably at least 99% by volume,
the discharge line for the gasifier gas produced in the fusion gasifier leads into the desulfurizing device,
the desulfurizing device is formed as at least one reactor with a moving bed or fluidized bed, which is connected in conducting terms to the fusion gasifier for feeding in used desulfurizing agent,
the feed for oxygen-containing gas is a feed for pure oxygen, and
a branch line which is provided with a control device and leads into the combustion chamber branches off from the discharge line for flue gases.

According to a preferred embodiment, the at least one desulfurizing reactor has a feed for iron and/or iron ore and a tap for pig iron is additionally provided in the fusion gasifier.

The tap for pig iron is preferably connected here in conducting terms to the feed for iron and/or iron ore.

A further preferred embodiment of the installation is characterized in that the desulfurizing device is formed as a fluidized bed reactor cascade, a feed for fine ore leading into the fluidized bed reactor arranged first in the cascade in the direction of material transport, both a connection in conducting terms for the gasification gas and one for the fine ore and the desulfurizing agent being provided between the fluidized bed reactors, and the discharge line for the gasifier gas produced in the fusion gasifier leading into the fluidized bed reactor arranged last, which is connected in conducting terms to the fusion gasifier for feeding in used desulfurizing agent and pre-heated and pre-reduced fine ore, and in that a tap for pig iron is provided in the fusion gasifier.

### DESCRIPTION OF THE INVENTION

The gasification of the carbon-containing fuel or the coal takes place with pure oxygen or gas containing a large amount of oxygen, in order that only carbon monoxide, hydrogen and small amounts of carbon dioxide and water vapor are produced as the gasification gas, and no nitrogen, or only very small amounts of nitrogen, get into the process. By setting a temperature of >800° C. in the gas space of the fusion gasifier, after a residence time of the gas of several seconds the organic burden of the gas is effectively reduced.

For feeding the raw materials into the high pressure space of the installation from atmospheric pressure, it is necessary with what are known as pressure locks (interlockings) for an intermediate vessel to be alternately coupled and uncoupled, to allow the transport of material to take place. Nitrogen is usually used as the inert gas for these coupling operations. However, CO₂ or mixtures of CO, H₂, CO₂ and water vapor is/are primarily used according to the invention as the inert gas for all purging operations in the process, in order to avoid the introduction of nitrogen or other gases that are difficult to eliminate.

Used as the gasifier is a modified fusion gasifier, which operates with a solid bed or partially fluidized coal/char bed, only liquid slag being produced from the coal ash.

According to the invention, a desulfurizing chamber or a moving bed reactor through which the gasifier gas flows and from which the desulfurizing agent, for example lime, is fed after use into the fusion gasifier, in order to produce a slag that can be used by the cement industry, is provided for desulfurizing the gas. In this way, waste can be avoided. This slag also takes up other pollutants from the ashes of the materials used as feedstock. They are safely bound up in the cement, and consequently no longer constitute a risk to the environment.

According to one embodiment of the invention, also fed into the desulfurizing zone, in addition to desulfurizing agent, are iron particles or iron ore, which likewise bind the sulfur compounds from the gasifier gas and, by feeding them into the gasifier, convert them into slag suitable for cement and liquid iron. The iron tapped off can be fed back to the desulfurizer, and consequently circulated without any appreciable consumption of iron. The liquid iron in the hearth of the fusion gasifier additionally facilitates the tapping off of the slag in an advantageous way, in particular after operational downtimes, when slag has solidified and can no longer be melted by conventional means. Iron in the hearth can be melted by means of oxygen through the tap and combined with solidified slag to form a flowable mixture of oxidized iron and slag. In this way, a “frozen” fusion gasifier can be put back into operation.

However, iron particles or iron ore as well as additives such as chalk for example may also be fed into the desulfurizing zone. The tapped-off pig iron can be further processed in a conventional way, for example to form steel.

Instead of the moving bed reactor, a fluidized bed reactor may also be used for the desulfurization, or a fluidized bed cascade may be used to obtain a more uniform residence time of the feedstock. This allows even fine-grain feedstock with grain sizes <10 mm to be used.

As also in the case of a blast furnace or in the case of direct reduction installations, an excess gas is thereby produced, still having a considerable energy content (export gas).

Examples of the gas composition of such export gases are:

| | | | | | | | Hᵤ |
|---|---|---|---|---|---|---|---|
| | CO % | H₂ % | CO₂ % | CH₄ % | H₂S ppm | N₂ % | MJ/mₙ³ |
| COREX ® | 35-40 | 15-20 | 33-36 | 1-3 | 10-70 | 4-6 | 7.5 |
| Top gas | 17-20 | 1-2 | 20-25 | | | rest | 3.5-4 |
| FINEX ® | 35-40 | 15-20 | 35 | 1-3 | 10-70 | 4-6 | 7.5 |

Like gasification gas, this gas can be burned in a gas turbine. For this purpose, in order that no nitrogen or only very little nitrogen enters, pure oxygen or a gas containing a large amount of oxygen with at least 95% by volume of O₂, preferably at least 99% by volume of O₂, is used in the fusion gasifier.

In order to lower the high combustion temperatures to the optimum range for the turbine, returned pure carbon dioxide is used according to the invention as a moderator. CO₂, which has a much higher specific heat capacity than nitrogen, and consequently produces lower gas volumes, is used in the gas turbine for setting the temperature in the combustion space. This leads to installations that are smaller, and consequently less expensive. This CO₂ may be provided by returning part of the flue gas. The absence of N₂ in the fuel gas mixture (as a result of the use of pure oxygen or a gas with at least 99% by volume of O₂) also means that no harmful NOx can be formed.

The very high content of CO₂ in the waste gas from the gas turbine that is achieved according to the invention makes better energy utilization in the downstream steam boiler possible as a result of the increased radiation in comparison with flue gases containing nitrogen. This allows a specifically higher output of the boiler installation to be achieved.

A further advantage is that the smaller gas volumes also mean that the downstream waste heat boiler, the gas lines and the gas treatment devices can be made smaller and less expensive.

Concentration of the CO₂ contained in the waste gas of the steam boiler is not necessary (as it is in the case of the processes that are currently used), since no ballast gases are contained in the flue gas and the water vapor that is contained does not present any problem.

The separation of the water vapor contained in the flue gases can be carried out easily and inexpensively by condensation on the basis of various known processes, such as spray-type cooling or indirect heat exchange.

By returning it to the gas turbine, the CO₂ obtained in this way can on the one hand be used without significant costs as a temperature moderator and on the other hand it can be passed on to sequestering in a known way.

The process according to the invention also means that no sophisticated H₂S/COS removal is necessary. There is also no need to install an installation for this purpose. A shift reaction is also unnecessary, and consequently an expensive and energy-intensive installation is likewise not required.

### EXAMPLE

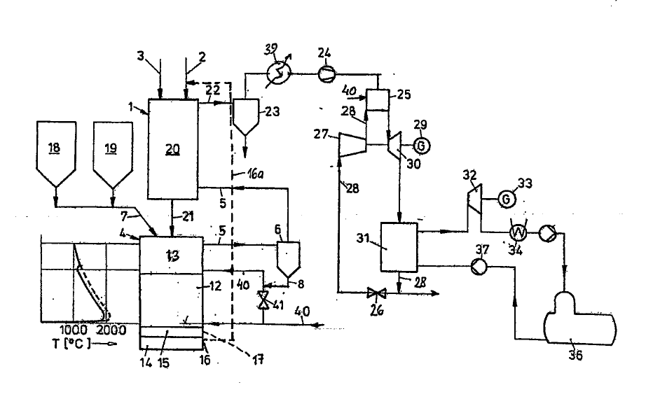

FIG. 1 represents an embodiment of the present invention.

Ore 2 and additives 3, such as lime, are fed into the moving bed reactor 1 by means of feeding devices. The charge 20 formed in this way is pre-heated in countercurrent with the dedusted gas from the cyclone 6, partly calcined and partly reduced. After that, this (partly) reduced charge 21 is fed by means of discharging devices through the free space 13 of the fusion gasifier 4 into its char bed 12. This char bed 12 is formed by high-temperature pyrolysis from carbon carriers 7, which come from the coal bunkers 18, 19, by the hot gasification gases of the nozzles blowing in oxygen 40. In this hot char bed 12, the (partly) reduced charge 21 is completely reduced and calcined and subsequently melted to form pig iron 14 and slag 15. The temperature conditions in the char bed 12 are indicated by way of example in the diagram represented in FIG. 1.

The pig iron 14 and the slag 15 are tapped off at intervals by way of the tapping opening 16. According to a further embodiment, the slag 15 is tapped off separately from the pig iron 14 by way of a tapping opening 17 of its own (represented by dashed lines). The tapped-off pig iron can then be returned again to the moving bed reactor 1 for renewed used as a desulfurizing agent (connection 16a, represented by dashed lines).

The raw gas (gasifier gas) 5 leaves the fusion gasifier 4 at the upper end of the free space 13 and is cleaned in the cyclone 6 of the hot dusts 8, which are returned to the free space 13 of the fusion gasifier 4 with oxygen 40 fed in by way of a control valve 41 and are gasified and melted there. The melt produced in this way is taken up by the char bed 12 and transported downward to the slag and pig iron bath 14, 15. The dedusted gas 5 enters the moving bed reactor 1 at temperatures of, for example, 800° C. and then causes the reactions described above, and is thereby oxidized to a thermodynamically predetermined degree and cooled. At the upper end of the moving bed reactor 1, the raw export gas 22 leaves the same. Since it still contains dust, it is cleaned in a downstream dust separator 23 and cooled in a cooler 39. The latter may be designed in such a way that a large part of the enthalpy of this gas can be recovered.

In the compressor 24, the cleaned and cooled gas is brought to the pressure necessary for the combustion in the combustion chamber 25 of the gas turbine 30 and, in the combustion chamber 25, it is burned together with oxygen 40 and the flue gases 28 (substantially carbon dioxide) compressed in the compressor stage 27. The combustion gases then pass through the gas turbine 30, the mechanical energy produced thereby being given off to the coupled generator 29.

The still hot waste gas from the gas turbine 30 is then fed to the downstream steam boiler 31. In this, hot steam is produced and this is used in the downstream steam turbine 32 for generating mechanical energy, which is transferred to the generator 33. The spent steam is condensed in a condenser 34 and fed to a hold-up tank 36. The condensate is returned to the steam boiler 31 by way of the condensate pump 37.

The flue gases 28 leaving the steam boiler 31 comprise pure carbon dioxide and some water vapor. They can then be introduced into the combustion chamber 25 by way of the control device 26 and the compressor 27 for setting the temperature. The rest can be passed on for sequestering after condensation of the water vapor content, or be given off into the atmosphere without treatment.

In the case of using fine ore, a fluidized bed reactor or a cascade of at least two fluidized bed reactors is installed instead of the moving bed reactor 1.

1. A process for generating electrical energy in a gas and steam turbine power generating plant with a gasification gas produced from carbon carriers and oxygen-containing gas, the method comprising:
gasifying carbon carriers in a gassing zone with oxygen or a gas with an oxygen content of at least 95% by volume producing gasification gas, passing the produced gasification gas through a desulfurizing zone containing a desulfurizing agent to produce desulfurized degasification gas, feeding used desulfurizing agent into the gassing zone and drawing off the used desulfurizing agent after the formation of a liquid slag, burning the desulfurized gasification gas in a combustion chamber together with pure oxygen resulting in combustion gases H₂O and CO₂ and introducing the resulting combustion gases H₂O and CO₂ into the gas turbine for energy generation,
downstream of the gas turbine, separating the combustion gases in a steam boiler into water vapor and carbon dioxide, subsequently introducing the water vapor into a steam turbine, at least partially returning the carbon dioxide to the combustion chamber for setting a temperature in the combustion chamber,
additionally feeding iron ore in the desulfurizing zone together with the used desulfurizing agent into the gassing zone, melting the iron ore there and drawing off the iron ore.

2. The process as claimed in claim 1, further comprising feeding iron as an auxiliary agent in the desulfurizing zone along with the used desulfurizing agent into the gassing zone, melting the iron in the desulfurizing zone and drawing off the iron.

3. The process as claimed in claim 2, further comprising returning the iron drawn off from the gassing zone to the desulfurizing zone.

4. The process as claimed in claim 1, further comprising pre-heating and pre-reducing in the desulfurizing zone the iron ore additionally used in the desulfurizing zone, feeding the iron ore together with the used desulfurizing agent into the gassing zone, and completely reducing the iron ore, melting the iron ore, and drawing off the ore as pig iron.

5. The process as claimed in claim 4, further comprising performing the desulfurizing of the gasifier gas and the pre-heating and pre-reduction of the iron ore in two or more fluidized bed zones arranged one behind the other, passing the iron ore from one fluidized bed zone to another fluidized bed zone, and flowing the gasifier gas through the fluidized bed zones in a direction counter to a direction of the iron ore.

6. The process as claimed in claim 1, further comprising setting a temperature >800° C., in the gassing zone.

7. The process as claimed in claim 1, further comprising performing purging operations during the process using CO₂ or a mixture of CO, H₂, CO₂ and water vapor.

8. The process as claimed in claim 1, further comprising using the liquid slag formed in the gassing zone in cement production.

9. An installation for carrying out a process for generating electrical energy in a gas and steam turbine power generating plant with a gasification gas produced from carbon carriers and oxygen-containing gas, the installation comprising
a gasifier for carbon carriers, including a feed for carbon carriers, a feed line for an oxygen-containing gas, a discharge line for liquid slag and a discharge line for the gasifier gas produced,
a desulfurizing device including a feed for desulfurizing agent and a discharge line for the cleaned gasifier gas and a feed for the gasifier gas which leads into the discharge line,
a combined gas and steam turbine power generating plant with a combustion chamber of the gas turbine installation, a line for the cleaned gasifier gas leads into the combustion chamber and a feed into the combustion chamber for oxygen-containing gas or for a gas containing a large amount of oxygen, which has an oxygen content of at least 95% by volume,
the plant further comprising a steam boiler of the steam turbine installation, a line for the combustion gases extending from the gas turbine leading into the steam boiler, a discharge line from the boiler for flue gases,
the gasifier having a fusion gasifier comprising at least one of a coal and a char bed, a tap from the gasifier for liquid slag and a discharge line for the gasifier gas produced in the fusion gasifier and leading into the desulfurizing device,
the desulfurizing device comprising at least one reactor with a moving bed or a fluidized bed, the reactor being connected for conducting to the fusion gasifier for feeding in used desulfurizing agent, a branch line having a control device, the branch line leads into the combustion chamber and branches off from the discharge line for flue gases from the gas turbine and in the steam boiler, downstream of the gas turbine, and operative such that the combustion gases are separated into water vapor and carbon dioxide, so that the water vapor can be subsequently introduced into a steam turbine, the at least one reactor having a feed for iron and/or iron ore, and a tap for pig iron in the fusion gasifier.

10. The installation as claimed in claim 9, wherein the tap for pig iron is connected in conducting terms to the feed for iron and/or iron ore.

11. The installation as claimed in claim 9, wherein the desulfurizing device comprises a fluidized bed reactor cascade, a feed for fine ore leading into the fluidized bed reactor arranged first in the cascade in the direction of material transport, a connection in conducting terms for the gasification gas and a connection for the fine ore and the desulfurizing agent being provided between the fluidized bed reactors, and a discharge line for the gasifier gas produced in the fusion gasifier leading into the fluidized bed reactor arranged last, the last fluidized bed reactor being connected in conducting terms to the fusion gasifier for feeding in used desulfurizing agent and pre-heated and pre-reduced fine ore, and a tap for pig iron provided in the fusion gasifier.

12. The process of claim 1, further comprising cleaning and cooling the desulfurized gasification gas prior to burning that gas in the combustion chamber.

13. The process of claim 1, wherein the oxygen or gas used for gasifying in a gassing zone has an oxygen content of at least 99% by volume.

14. The process of claim 1, further comprising setting a temperature >850° C., in the gassing zone.
